(19) United States
(12) Patent Application Publication
(10) Pub. No.: US 2013/0250096 A1
(43) Pub. Date: Sep. 26, 2013

(54) DEVICE FOR EQUIPMENT ALIGNMENT

(71) Applicant: Thomas Rydqvist, Enskededalen (SE)

(72) Inventor: Thomas Rydqvist, Enskededalen (SE)

(73) Assignee: FLIR SYSTEMS AB, Danderyd (SE)

(21) Appl. No.: 13/807,595

(22) PCT Filed: Jun. 20, 2011
(86) PCT No.: PCT/SE11/00119

§ 371 Date: Jun. 7, 2013

(30) Foreign Application Priority Data
Jun. 29, 2010 (SE) 1000697-1

(51) Int. Cl. G01B 11/14

(52) U.S. Cl. CPC G01B 11/14
USPC 348/95

(57) ABSTRACT

A device for equipment alignment. The device is configured as a separate unit for arrangement in front of an aiming mark generating device and includes a first input port configured to receive an aiming mark. A second input port is configured to receive an image of a region under observation from the alignment device. An output port is configured to couple to a detector. The device is arranged to accommodate a corner-cube prism and a beam divider plate. The beam divider plate is arranged at an angle of 45 degrees relative to the input port and at an angle of 45 degrees to the front face of the corner-cube prism.

### TECHNICAL FIELD

The present invention relates to a device for equipment alignment.

### BACKGROUND

Equipment alignment is required in many contexts. Even as different instruments are installed, it is necessary to ensure that these are mutually aligned. Further alignment is required when instruments are exchanged and repaired. It is also valuable to be able to check and align integral instruments after a certain period of use or following transportation. Both simple and more sophisticated methods of aligning integral instruments are found.

The object of the present invention is to provide a device for equipment alignment which is simple in terms of its design and can be used under field conditions.

### SUMMARY OF THE INVENTION

The object of the invention is achieved by an alignment device characterized in that the device is configured as a separate unit for arrangement in front of an aiming mark generating device and comprises a first input port for the reception of an aiming mark, a second input port for the reception of an image of a region under observation from the alignment device, and an output port for coupling to a detector, the device being arranged to accommodate a corner-cube prism and a beam divider plate, which beam divider plate is arranged at an angle of 45 degrees relative to the input port and at an angle of 45 degrees to the front face of the corner-cube prism.

The proposed alignment device has a number of advantages. The apparatus is invariant insofar as it does not need to be adjusted in angle, since this characteristic is not altered between different images. Another advantage is that the device does not require any power supply. Furthermore, the apparatus can be made in compact construction, resulting in lower weight and less costly components and thus a lower overall price. For example, compact corner-cube prisms, which have both a lower price and a lower weight, can be used. In principle, the alignment device can be used wherever there is a need to make two antiparallel beams parallel and angled-out.

In this context, it can be mentioned that the principle of combining a corner-cube prism and a beam splitter plate in like manner to see what is being surveyed is previously known by virtue of, for example, U.S. Pat. No. 5,291,263. This concerns an integral part to a relatively complex system, whilst our solution offers a simple and cost-effective solution for realizing an alignment of equipment which is to interact.

According to one proposed embodiment, the first input port for the reception of an aiming mark and the second input port for the reception of an image are arranged substantially along a first straight line, and the output port coupled to a detector is arranged substantially along a second straight line perpendicular to the first straight line. The embodiment offers a simple, compact alignment device.

The detector is proposed according to various alternatives, constituted by the eye of an observer, or a camera, such as a CCD camera. The direct use of the eye as a detector means that no further components are required and the complete system is wholly independent of a power supply.

Advantageously, the region under observation is constituted by a landscape and a spot marked by the aiming mark is constituted by a well-defined detail in the landscape. The choice of a well-defined detail facilitates the alignment of equipment which needs to be aligned with laser rangefinders such as, for example, IR cameras and CCD cameras.

The region under observation can also be constituted by other regions than a landscape view. For example, it may be a case of more closely situated subjects and also indoor subjects, in which the alignment can be carried out in one and the same room. In order to position the subject at a great or infinite distance away, a collimator is here arranged adjacent to that port of the alignment device which is facing the subject. It is here particularly proposed that the device for the alignment of the equipment is provided with a collimator adjacent to that port of the device which is facing towards the region under observation.

In order to improve the resolution of an image delivered to the output port, according to one advantageous embodiment a field glass is arranged adjacent to the output port. Through the introduction of a field glass, an improved resolution compared with the ⅓-⅕ mrad of the eye, which resolution, moreover, can be chosen according to requirement, is obtained.

According to one suitable embodiment, the beam splitter plate with respect to radiation from the aiming mark, configured to transmit the majority of the radiation and reflect a minor part, is proposed. Preferably, the beam splitter plate can be arranged to transmit between 86 and 90 percent and to reflect the remaining 10 to 14 percent.

It is especially proposed that the received aiming mark is generated by an aiming mark generating device in the form of a rangefinder such as a laser rangefinder with direction collimator. A common requirement is to align cameras, such as CCD cameras, IR cameras and other video cameras, with a laser rangefinder, and thus an aiming mark generating device is already available.

### BRIEF DESCRIPTION OF DRAWINGS

The invention will be further described below by means of an illustrative embodiment with reference to the appended drawings, in which:

FIG. 1 shows in schematic representation a device for equipment alignment according to the principles of the invention.

FIG. 2 shows in schematic representation examples of equipment which can be aligned by means of the device according to the invention.

### DETAILED DESCRIPTION OF EMBODIMENTS

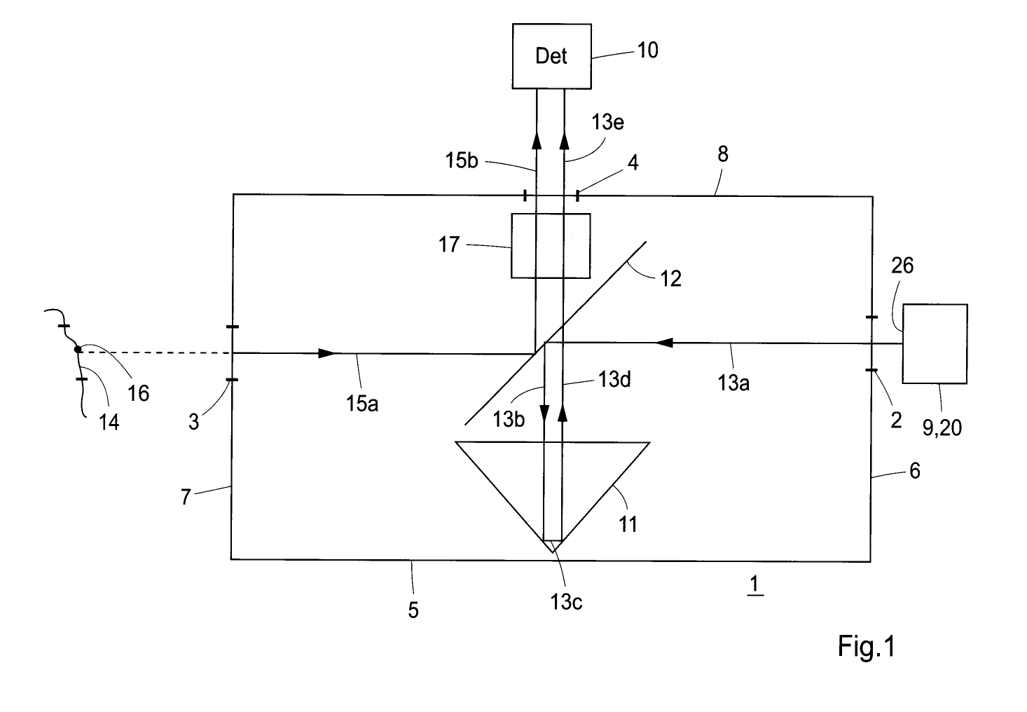

In FIG. 1 is shown a device 1 for equipment alignment. The device comprises a first input port 2 and a second input port 3, as well as an output port 4.

All the ports are arranged in a housing 5 and such that the first and second input ports 2, 3 are essentially arranged directly one in front of the other in two opposite sides 6, 7 of the housing 5, whilst the output port 4 is arranged in a housing part 8 connecting the sides/the housing parts 6, 7. The first input port 2 is intended to receive an aiming mark from an aiming mark generating device 9, and preferably a laser rangefinder with direction collimator. The opposite second input port 3 is arranged to receive an image of a region under observation by the alignment device 1. The observed region can be a part of a landscape 14, which is superimposed by a luminous aiming mark from the aiming mark generating device 9 in a spot 16. The output port 4 is coupled to a detector 10 in the form of the eye of an observer, a camera such as a CCD camera or another similar suitable detector. The housing 5 of the alignment device 1 accommodates a corner-cube prism 11 and a beam splitter plate 12. The beam splitter plate 12 forms an angle of 45 degrees with the input port 2 and the front face of the corner prism 11 is arranged at an angle of 45 degrees relative to the beam splitter plate 12. A collimator (not shown) of known design can be arranged adjacent to that port 3 of the device which is facing the region under observation.

In order to acquire better resolution than the approx. ⅓-⅕ mrad of the eye, the apparatus can be equipped with a field glass 17 with the desired enlargement adjacent to the output port 4 of the alignment device 1.

The beam path for the alignment device 1 is explained below.

An aiming mark generated by the aiming mark generating device 9 enters the housing 5 via the first input port 2. The utilized part of the aiming mark follows a path denoted by 13a-13e and, more precisely, such that the aiming mark, in the passage from the path part 13a to 13b, is reflected in the beam splitter plate 12 and leaves the beam splitter plate realigned by 90 degrees. After this, the aiming mark meets the corner-cube prism 11 and its path undergoes a 90-degree realignment in the passage between the path part 13b-13c and a 90-degree realignment in the passage between the path part 13c-13d. After this, the aiming mark again meets the beam splitter 12 and the utilized part of the aiming mark is transmitted by the beam splitter plate 12 to the detector 10 via the path parts 13d and 13e.

The second input port 3 of the alignment device 1 at the same time receives an image from a surrounding landscape 14. The image follows the path part 15a to the beam splitter plate, where it is reflected to be redirected by 90 degrees and follow a path part 15b onward to the detector 10. The reference symbol 16 indicates a spot or point corresponding to the target point for an aiming mark generated by the aiming mark generating device 9, in the absence of a fitted alignment device.

By virtue of the specified design, a device which makes two antiparallel beams parallel and angled-out by 90 degrees has been realized. One beam can here emanate from the landscape towards which the alignment device is directed, and the second beam from the aiming mark.

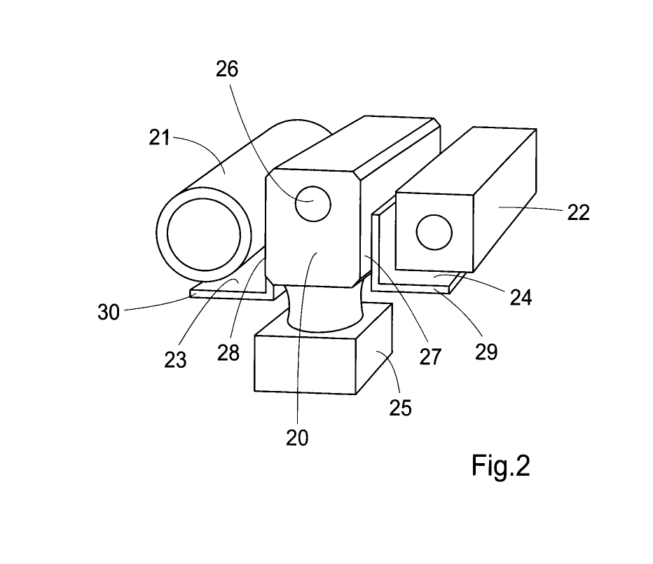

An alignment process is described below with reference to FIG. 2.

In this figure is shown a laser rangefinder 20 with aiming mark function. On one side of the laser rangefinder 20 is arranged an IR camera 21 and on the other side a CCD camera 22. In this shown example, the IR camera and the CCD camera are each mounted on a respective angle iron 23 and 24. One angle part 27 or 28 is here adjustably fastened to the laser rangefinder 20, whilst the other angle part 29 or 30 is adjustably fastened to the respective camera 21 or 22. The fastening of the IR camera 21 and the CCD camera 22 is such that they can be adjusted by, for example, screw joints (not shown in detail), firstly with respect to the part of the angle iron which holds the respective camera and, secondly, with respect to the part which bears against the laser rangefinder 20. In this way, the setting of the cameras relative to the laser rangefinder 20 is able to be adjusted both in azimuth and in elevation. The laser rangefinder with mounted cameras 21, 22 is in turn mounted on a mount 25, which allows the laser rangefinder, together with mounted cameras 21, 22, to be jointly rotated in both the azimuth and the elevation direction.

In the alignment of the cameras 21 and 22, the alignment device according to FIG. 1 is first held in front of the output 26 of the aiming mark on the laser rangefinder 20, with the first input port 2 of the alignment device facing towards the output 26. A detector 10, such as the eye of an observer, then sees at the output port 4 a landscape 14 with the aiming mark superimposed onto a point in the landscape. If the point is poorly identified, the laser rangefinder with suspended cameras can be somewhat adjusted in elevation or azimuth to find a more easily identifiable point. The point which is now shown in the landscape 14 is the point to which the distance is measured by the laser rangefinder 20. In a next step, the corresponding point in the respective camera/equipment to be aligned is identified, whereupon the camera/the equipment is adjusted in azimuth and elevation so that the point identified in the landscape acquires a corresponding position in the camera image. For example, the identified point is made to correspond, in the image of the camera, to a central sight marking.

The invention is not limited to the embodiments described above by way of example, but can be subjected to modifications within the scope of the following patent claims.

1. A device for equipment alignment, wherein the device is configured as a separate unit for arrangement in front of an aiming mark generating device, the device comprising:
a first input port configured to receive an aiming mark;
a second input port configured to receive an image of a region under observation from the device;
an output port configured to couple to a detector;
a corner-cube prism; and
a beam divider plate is arranged at an angle of 45 degrees relative to the input port and at an angle of 45 degrees to a front face of the corner-cube prism.

2. The device according to claim 1, wherein the first input port for the reception of an aiming mark and the second input port for the reception of an image are arranged substantially along a first straight line, and wherein the output port coupled to a detector is arranged substantially along a second straight line perpendicular to the first straight line.

3. The device according to claim 1, wherein the detector comprises an eye.

4. The device according to claim 1, wherein the detector comprises a camera, such as a CCD camera.

5. The device according to claim 1, wherein region under observation comprises a landscape, and wherein a spot marked by the aiming mark comprises a well-defined detail in the landscape.

6. The device according to claim 1, further comprising:
a collimator adjacent to that port of the device which is facing towards the region under observation.

7. The device according to claim 1, further comprising:
a field glass is arranged adjacent to the output port to improve a resolution of an image delivered to the output port.

8. The device according to claim 1, wherein the beam splitter plate with respect to radiation from the aiming mark is configured to transmit a majority of the radiation and reflect a minor part of the radiation.

9. The device according to claim 8, wherein the beam splitter plate is arranged to transmit between 86 and 90 percent and to reflect the a remaining 10 to 14 percent.

10. The device according to claim 1, further comprising:
an aiming mark-generating device configured to generate the aiming mark, wherein the aiming mark-generating device comprises a rangefinder.
